(19) United States
(12) Patent Application Publication
(10) Pub. No.: US 2024/0166522 A1
(43) Pub. Date: May 23, 2024

(54) METHOD FOR PREPARING PETCOKE-BASED ARTIFICIAL GRAPHITE NEGATIVE ELECTRODE MATERIAL FOR LITHIUM SECONDARY BATTERY, ARTIFICIAL GRAPHITE NEGATIVE ELECTRODE MATERIAL FOR LITHIUM SECONDARY BATTERY PREPARED THEREBY, AND LITHIUM SECONDARY BATTERY

(71) Applicant: KOREA RESEARCH INSTITUTE OF CHEMICAL TECHNOLOGY, Daejeon (KR)

(72) Inventors: Young-Pyo JEON, Daejeon (KR); Seung-Hyun KO, Daejeon (KR); Hyun-Sig KIL, Daejeon (KR); Seung-Jae HA, Daejeon (KR); Hyo-Cheol LEE, Daejeon (KR); Min-Seong JO, Daejeon (KR)

(21) Appl. No.: 18/282,815

(22) PCT Filed: Mar. 29, 2022
(86) PCT No.: PCT/KR2022/004463

§ 371 Date: Sep. 19, 2023

(30) Foreign Application Priority Data
Apr. 5, 2021 (KR) 10-2021-0044125

(51) Int. Cl. C01B 32/205; H01M 4/02; H01M 4/583; H01M 10/052

(52) U.S. Cl. CPC C01B 32/205; H01M 4/583; H01M 10/052; C01P 2002/72; C01P 2004/03; C01P 2004/61; C01P 2006/40; H01M 2004/027

(57) ABSTRACT

The present invention provides: a method for preparing a petcoke-based artificial graphite negative electrode material for a lithium secondary battery, in which low-grade petcoke is used as a raw material, and artificial graphite having a high degree of graphitization is prepared through leaching and acid treatment of pulverized/classified low-grade petcoke in an acidic solution, followed by carbonization and graphitization; an artificial graphite negative electrode material for a lithium secondary battery, prepared thereby; and a lithium secondary battery.

### TECHNICAL FIELD

The present disclosure relates to a method of preparing an artificial graphite negative electrode material from petcoke for a rechargeable lithium battery, an artificial graphite negative electrode material for a rechargeable lithium battery prepared from the method, and a rechargeable lithium battery. In more detail, the present disclosure relates to a method of preparing an artificial graphite negative electrode material from petcoke for a rechargeable lithium battery, the method preparing artificial graphite having a high degree of graphitization by using inferior petcoke as a raw material, leaching acidifying the inferior petcoke, which has been comminuted and classified, in an acid solution, and then performing carbonization and graphitization; an artificial graphite negative electrode material for a rechargeable lithium battery prepared from the method; and a rechargeable lithium battery.

### BACKGROUND ART

Recently, a high-capacity rechargeable lithium battery is required due to an increase of power consumption by electronic devices and the charging/discharging cycle of batteries decreases due to an increase of use time. It is required to increase the charging/discharging cycle lifespan of batteries due to such reduction of a charging/discharging cycle.

Natural graphite, artificial graphite, etc., have been succeeded in commercialization and are currently generally applied as the negative electrode material of rechargeable lithium batteries, and particularly, a natural graphite negative electrode material shows high capacity in comparison to an artificial graphite negative electrode material. However, despite the high-capacity characteristic of the natural graphite negative electrode material, the natural graphite negative electrode material has been known as having a poor lifespan characteristic in comparison to the artificial graphite negative electrode material.

In particular, since natural graphite has a crystalline (plate) form in most cases, spherodized natural graphite is generally used to make an electrode preparing process easy, increase a packing density, improve an output characteristic, etc. It has been known that the lifespan characteristic of natural graphite is damaged in a repeated charging/discharging process due to the defect, internal stress, etc. of a graphite structure formed through a spherodization process. On the contrary, the artificial graphite negative electrode material is lower in capacity than the natural graphite negative electrode material, but has an excellent charging/discharging lifespan characteristic.

In general, the raw material that is used in the process of preparing an artificial graphite negative electrode material is needle coke and has the advantage of high purity and high crystallizability, so when it is used as the negative electrode material of a rechargeable battery, it shows characteristics such as high specific capacity, high coulombic efficiency, and a long cycle life. However, the price of the raw material itself is high and price fluctuation is large, which acts as an obstacle to cost-lowering of negative electrode materials.

FIG. 1 is a process flowchart of a method of preparing artificial graphite for a negative electrode material of a rechargeable lithium battery according to the related art.

Referring to FIG. 1, needle coke is comminuted into an appropriate size (S12) and is then a binder pitch and an additive for improving the performance of a negative electrode material are mixed (S15). Thereafter, the needle coke-binder pitch-additive compound is put into a mold with specific dimensions and then heated and pressed into a molding with a predetermined shape (S16). Next, volatile fractions are removed through carbonization heat treatment and the binder pitch is induced to be carbonized (S17), and finally, a graphite structure is formed through graphitization heat treatment (S18), and then the molding is comminuted and classified into an appropriate size to be able to be used as a negative electrode material (S19), whereby artificial graphite for a rechargeable lithium battery is manufactured.

On the other hand, petcoke, which is petroleum-based coke, is porous cheap coke obtained by thermally decomposing petroleum-based heavy oil fractions, such as oil sand, vacuum residue, FCC-DO, and LCO, at high temperature and has difficulty in showing a high degree of graphitization after heat treatment because it has a high content of impurities and low crystallizability in comparison to high-price needle coke, so it has been used as a heat source or an energy source through combustion without a specific usage in most cases. However, since petcoke produces air pollutants, such as greenhouse gas and particulate matter, in combustion, it is the fact that use of petcoke is recently limited by environmental regulation.

Further, it is the fact that there is no sufficient study on preparing of an artificial graphite negative electrode material that has similar performance to a needle coke-based artificial graphite negative electrode material and is inexpensive by solving problems such as a high content of impurities and a low degree of graphitization of petcoke.

### DISCLOSURE

### Technical Problem

Accordingly, an objective of the present disclosure is to provide a method of preparing an artificial graphite negative electrode material for rechargeable lithium battery that has similar performance to a needle coke-based artificial graphite negative electrode material and is inexpensive by solving problems such as a high content of impurities and a low degree of graphitization of petcoke.

Further, an objective of the present disclosure is to provide a rechargeable lithium battery using a petcoke-based low-cost artificial graphite negative electrode material for a rechargeable lithium battery using the method.

The objectives of the present disclosure are not limited to the objects described above and other objectives will be clearly understood by those skilled in the art from the following description.

### Technical Solution

In order to achieve the objectives, according to an aspect of the present disclosure, there is provided a method of preparing an artificial graphite negative electrode material from petcoke for a rechargeable lithium battery, the method including: a step of drying petcoke; a step of comminuting/classifying the petcoke; a step of removing inorganic impurities by leaching [symbol] acidifying the comminuted/classified petcoke in an acid solution; a step of obtaining a primary carbide by performing primary carbonization heat treatment on the petcoke with inorganic impurities removed; a step of obtaining a secondary carbide by performing secondary carbonization heat treatment on the primary carbide; and a step of obtaining artificial graphite by performing graphitization heat treatment on the secondary carbide at a temperature of 2500° C. to 3500° C., wherein the artificial graphite includes remaining inorganic impurities of 0.02% by weight to 6% by weight.

According to an embodiment of the present disclosure, the primary carbonization treatment may be performed at a temperature of 1000° C. to 1900° C.

According to an embodiment of the present disclosure, the secondary carbonization treatment may be performed at a temperature of 500° C. to 1000° C.

According to an embodiment of the present disclosure, the acid solution may be used by diluting one or more acids selected from a group of hydrochloric acid, nitric acid, sulfuric acid, phosphoric acid, and hydrofluoric acid with water in the leaching acidifying.

According to an embodiment of the present disclosure, the concentration of the acid solution may be 2% by weight to 50% by weight.

According to an embodiment of the present disclosure, the weight ratio of the petcoke and the acid solution may be 1:1˜1:30.

According to an embodiment of the present disclosure, the method may further include a step of removing remaining acid by leaching acidifying inorganic impurities into the acid solution and then performing washing with high-purity water.

According to an embodiment of the present disclosure, the drying may be performed at a temperature of 80° C. to 150° C.

According to an embodiment of the present disclosure, an average granular diameter d₅₀ of the petcoke after the drying and comminuting/classifying may be 1 μm≤d₅₀≤100 μM.

According to an embodiment of the present disclosure, the method may further include a step of kneading using the primary carbide, a binder pitch of which the softening point is 80° C. to 300° C., and a graphitization accelerant after the primary carbonization heat treatment.

According to an embodiment of the present disclosure, the graphitization accelerant is boron (B), boric acid (H₃BO₃), diboron trioxide (B₂O₃), or boron carbide (B₄C), and the weight of boron to the final carbon weight remaining after graphitization heat treatment may be 1% by weight to 10% by weight.

According to an embodiment of the present disclosure, the method may further including a step of forming by heating/pressing a mixture of the primary carbide, the binder pitch, and the graphitization accelerant in a matrix (mold) after the kneading.

According to an embodiment of the present disclosure, the method may further include a step of comminuting/classifying after the graphitization heat treatment.

According to an embodiment of the present disclosure, an average granular diameter d₅₀ of the graphite particles produced after the graphitization heat treatment and the comminuting/classifying may be 2 μm≤d₅₀≤50 μm.

According to an embodiment of the present disclosure, the method may further include a step of carbon coating after the graphitization heat treatment and before the comminuting/classifying.

Further, according to an embodiment of the present disclosure, there is provided an artificial graphite negative electrode material for a rechargeable lithium battery prepared by the method of preparing an artificial graphite negative electrode material from petcoke for a rechargeable lithium battery.

According to the present disclosure, a gap d₀₀₂ of crystal planes of the artificial graphite negative electrode material may be 3.354 Å to 3.379 Å.

According to the present disclosure, a z-axial crystallite size L_{c} of the artificial graphite negative electrode material may be 19 nm to 100 nm.

### Advantageous Effects

Further, according to an embodiment of the present disclosure, there is provided a rechargeable lithium battery made of the artificial graphite negative electrode material for a for rechargeable lithium battery.

According to the present disclosure, since a negative electrode material for a rechargeable lithium battery is prepared using cheap petcoke of which the price fluctuation is small and is produced in a large quantity, it is economical.

Further, the present disclosure provides a method of preparing an artificial graphite negative electrode material for rechargeable lithium battery that has similar performance to a needle coke-based artificial graphite negative electrode material and is inexpensive by solving problems such as a high content of impurities and a low degree of graphitization of petcoke.

Further, the present disclosure provides a rechargeable lithium battery made of a petcoke-based inexpensive artificial graphite negative electrode material for a rechargeable lithium battery.

The effects of the present disclosure are not limited thereto and it should be understood that the effects include all effects that can be inferred from the configuration of the present disclosure described in the following specification or claims.

### DESCRIPTION OF DRAWINGS

FIG. 1 is a process flowchart of a method of preparing artificial graphite for a negative electrode material of a rechargeable lithium battery according to the related art.

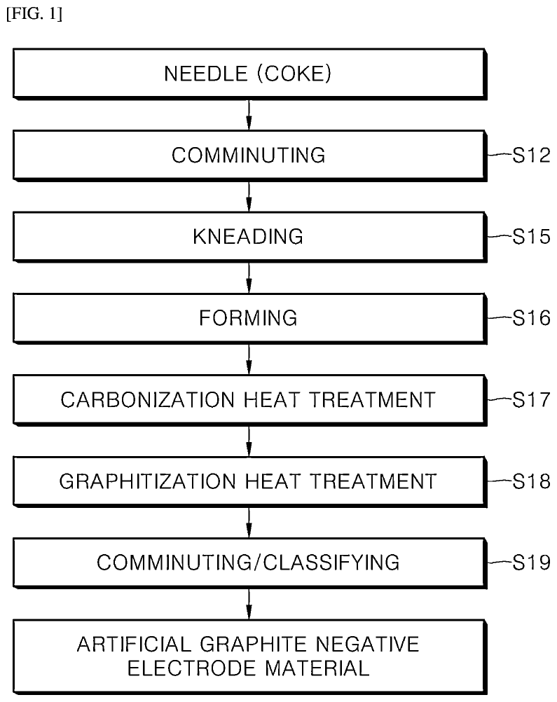

FIG. 2 is a process flowchart of a method of preparing artificial graphite for a negative electrode material of a rechargeable lithium battery according to an embodiment of the present disclosure.

FIG. 3 is a diagram showing an X-ray diffraction pattern of artificial graphite for negative electrode materials of a rechargeable lithium battery prepared in Embodiment 3, Embodiment 8, and Embodiment 9 of the present disclosure and Comparative example 1.

FIG. 4 is a scanning electron microscopic (SEM) image of the artificial graphite for a negative electrode material of a rechargeable lithium battery prepared in Embodiment 3.

### BEST MODE

Hereinafter, preferred embodiments of the present disclosure will be described with reference to accompanying drawings.

The advantages and features of the present disclosure, and methods of achieving them will be clear by referring to the exemplary embodiments that will be described hereafter in detail with reference to the accompanying drawings.

However, the present disclosure is not limited to the exemplary embodiments described hereafter and may be implemented in various ways, and the exemplary embodiments are provided to complete the description of the present disclosure and let those skilled in the art completely know the scope of the present disclosure and the present disclosure is defined by claims.

Further, when it is determined that well-known technologies, etc. may make the scope of the present disclosure unclear, they will not be described in detail in the following description.

Hereinafter, the present disclosure is described in detail.

Method of Preparing Artificial Graphite Negative Electrode Material from Petcoke for Rechargeable Lithium Battery

The present disclosure provides a method of preparing an artificial graphite negative electrode material from petcoke for a rechargeable lithium battery.

A method of preparing an artificial graphite negative electrode material from petcoke for a rechargeable lithium battery of the present disclosure includes:
a step of drying petcoke;
a step of comminuting/classifying the petcoke;
a step of removing inorganic impurities by leaching acidifying the comminuted/classified petcoke in an acid solution;
a step of obtaining a primary carbide by performing primary carbonization heat treatment on the petcoke with inorganic impurities removed;
a step of obtaining a secondary carbide by performing secondary carbonization heat treatment on the primary carbide; and
a step of obtaining artificial graphite by performing graphitization heat treatment on the secondary carbide at a temperature of 2500° C. to 3500° C., in which the artificial graphite includes remaining inorganic impurities of 0.02% by weight to 6% by weight.

In this case, the graphitization heat treatment is a step of converting a carbon structure into a graphite structure to maximally increase the degree of graphitization (crystallizability) and may be performed at a temperature of 2500° C.˜3500° C. for 10 minutes to 20 days.

In this case, when the graphitization heat treatment temperature is less than 2500° C., there is a problem that the degree of graphitization of the artificial graphite is not enough to use the artificial graphite as a negative electrode material of a rechargeable lithium battery, and when the graphitization heat treatment temperature exceeds 3500° C., there is a problem that the preparing cost increases.

Further, when the graphitization heat treatment time is less than 10 minutes, there is a problem that the degree of graphitization of the artificial graphite is not enough to use the artificial graphite as a negative electrode material of a rechargeable lithium battery, and when the graphitization heat treatment time exceeds 20 days, there is a problem that the preparing cost increases.

Further, in the content of inorganic impurities of 1% by weight to 20% by weight of petcoke that is a raw material, the remaining inorganic impurities of artificial graphite prepared by the method may decrease to 0.02% by weight to 6% by weight.

Further, the primary carbonization heat treatment may be performed at a temperature of 1000° C. to 1900° C.

In this case, the primary carbonization heat treatment is for removing volatile components, such as methane, ethane, and carbon dioxide, and organic impurities (S, N, O) included in the petroleum-coke raw material, so the heat treatment may be performed at 1000° C. to 1900° C. for 10 minutes to 5 hours.

When the primary carbonization heat treatment temperature is less than 1000° C., there is a problem that the volatile components are removed but the organic impurities (S, N, O) are not removed, and when the primary carbonization heat treatment temperature exceeds 1900° C., there is a problem that economical efficiency decreases.

Further, when the primary carbonization heat treatment time is less than 10 minutes, there is a problem that the volatile components are removed but the organic impurities (S, N, O) are not removed, and when the primary carbonization heat treatment time exceeds 5 hours, there is a problem that economical efficiency decreases.

Further, the secondary carbonization heat treatment may be performed at a temperature of 500° C. to 1000° C.

In this case, since the secondary carbonization heat treatment has only to be performed so that volatile component removal of the binder pitch and carbonization are sufficiently achieved, the secondary carbonization heat treatment can be performed at a temperature of 500° C. to 1000° C.

When the secondary carbonization heat treatment temperature is less than 500° C., there is a problem that volatile component removal of the binder pitch and carbonization are not sufficient, and when the secondary carbonization heat treatment temperature exceeds 1000° C., there is a problem that economical efficiency decreases.

Further, the secondary carbonization heat treatment may be performed at a temperature of 500° C. to 1000° C. for 10 minutes to 5 hours.

In this case, when the secondary carbonization heat treatment time is less than 10 minutes, there is a problem that volatile component removal of the binder pitch and carbonization are not sufficient, and when the secondary carbonization heat treatment time exceeds 5 hours, there is a problem that economical efficiency decreases.

Further, the acid solution may be used by diluting one or more acids selected from a group of hydrochloric acid, nitric acid, sulfuric acid, phosphoric acid, and hydrofluoric acid with water in the leaching acidifying.

In this case, the acid solution may be an acid solution of a single acid component and may be mixed acid of two or more selected from a group of hydrochloric acid, nitric acid, sulfuric acid, phosphoric acid, and hydrofluoric acid.

Further, the concentration of the acid solution may be 2% by weight to 50% by weight.

In this case, when the concentration of the acid solution is less than 2% by weight, there is a problem that inorganic impurities are not sufficiently leached and removed, and when the concentration of the acid solution exceeds 50% by weight, there is a problem of corrosion of a reaction container.

Further, the weight ratio of the petcoke and the acid solution may be 1:1˜1:30. In this case, when the weight ratio of the petcoke and the acid solution is less than 1:1, there is a problem that inorganic impurities are not sufficiently leached and removed, and when the weight ratio of the petcoke and the acid solution exceeds 1:30, there is a problem of corrosion of a reaction container.

Further, the method may further include a step of removing remaining acid by leaching inorganic impurities into the acid solution and then performing washing with high-purity water.

Further, the drying may be performed at a temperature of 80° C. to 150° C.

In this case, the drying is for removing water contained with the petcoke that is a raw material.

Further, the average granular diameter d₅₀ of the petcoke after the drying and comminuting/classifying may be 1 μm≤d₅₀≤100 μm.

In this case, the comminuting/classifying is for increasing the efficiency of leaching inorganic impurities.

Further, the method may further include a step of kneading using the primary carbide, a binder pitch of which the softening point is 80° C. to 300° C., and a graphitization accelerant after the primary carbonization heat treatment.

In this case, the graphitization accelerant is boron (B), boric acid (H₃BO₃), diboron trioxide (B₂O₃), or boron carbide (B₄C), and the weight of boron to the final carbon weight remaining after graphitization heat treatment may be 1% by weight to 10% by weight.

Further, the method may further include a step of forming by heating/pressing a mixture of the primary carbide, the binder pitch, and the graphitization accelerant in a matrix (mold) after the kneading.

Further, the method may further include a step of comminuting/classifying after the graphitization heat treatment.

Further, the average granular diameter d₅₀ of the graphite particles prepared after the graphitization heat treatment and the comminuting/classifying may be 2 μm≤d₅₀≤50 μm.

Further, the method may further include a step of carbon coating after the graphitization heat treatment and before the comminuting/classifying.

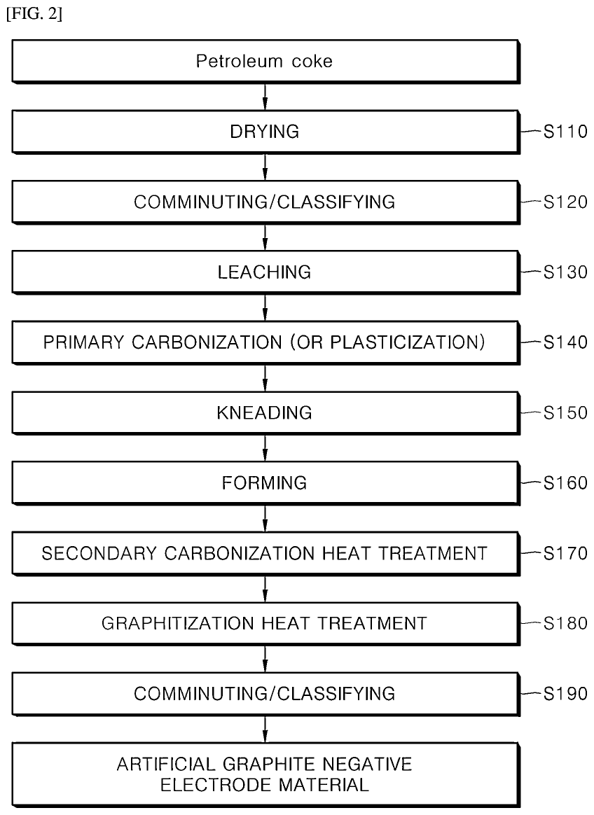

FIG. 2 is a process flowchart of a method of preparing artificial graphite for a negative electrode material of a rechargeable lithium battery according to an embodiment of the present disclosure.

Referring to FIG. 2, artificial graphite for a negative electrode material of a rechargeable lithium battery is prepared through the following preparing steps.

Drying (S110): Since petcoke that is a raw material is stacked and kept outside, it contains water of 5˜15% by weight and such water makes classification difficult by inducing cohesion of powder, so the water is removed through a drying step at a temperature of 80° C. to 150° C.

Comminuting/Classifying (Primary) (S120): The granular size of petcoke tends to be very large in which 13 mm or more is 77.8% and 13 mm or less is 22.2%, so comminuting/classifying is performed to reduce the average granular diameter d₅₀ to 1 μm≤d₅₀≤100 μm in order to increase leaching efficiency.

Leaching Acidifying (S130): Inorganic impurities are leached and removed by putting the classified powder petcoke into an acid solution and then stirring the acid solution for a predetermined time. Remaining acid is removed by performing washing with high-purity water after the leaching acidifying. It is possible to reduce the content of inorganic impurity elements to the level of 1/10 through the leaching acidifying.

Primary carbonization heat treatment (S140): Since volatile components such as methane, ethane, and carbon dioxide, which do not become graphite and go out in heat treatment, are included by about 8% by weight˜15% by weight in petroleum coke raw material, carbonization heat treatment is performed at a temperature of 1000° C. to 1900° C. for 10 minutes to 5 hours, thereby removing such volatile components and removing organic impurities (S, N, O) in the petroleum coke. The entire content of organic impurities before the primary carbonization heat treatment may decrease from 8% by weight to 15% by weight before carbonization to 0.5% by weight to 3% by weight.

Heat treatment temperature 1000° C.˜1900° C. (preferably, 1300° C.˜1700° C.)

Treatment time: 10 minutes to 5 hours (preferably, within 1 hour)

Temperature rising speed: 5° C./min˜20° C./min

In this case, there is a problem that volatile components such as methane, ethane, carbon dioxide mostly come out but organic impurities (O, N, S) are not removed even at a temperature less than 1000° C. In particular, the content of N and S little decreases. Heat treatment should be performed at 1000° C. or more, preferably, 1300° C. or more to remove such organic impurities.

The performing time of the primary carbonization is very important and the primary carbonization should be performed after leaching and before the kneading step.

The reason is as follows.

\textcircled{1} There is a problem that when it is performed between leaching acidifying, the inorganic impurity removal efficiency is considerably decreased in leaching acidifying.

\textcircled{2} Volatile components (hydrocarbon and carbon dioxide) and organic impurities (S, N, O) remaining in petcoke are discharged (about 15% by weight˜20% by weight) through the primary carbonization heat treatment, and a porous structure is formed in the petcoke by discharge of them. The porous structure formed in this way results in reduction of density and an increase of the specific surface area, which causes problems of efficiency reduction, capacity reduction, and lifespan reduction when it is used as a negative electrode material.

Thereafter, the kneading forming step serves to increase density by filling the porous structure formed in the primary carbonization. If kneading·forming is performed without primary carbonization, there is a problem that volatile components and organic impurities come out and form pores in secondary carbonization, which is performed after forming, and the porous structure in this case remains even in an artificial graphite negative electrode material.

Kneading (S150): It is a step of mixing the primary carbide and the binder pitch at a predetermined ratio for forming, and it adds a predetermined amount of graphitization accelerant to increase the degree of graphitization.

\textcircled{0} Binder pitch: A binder pitch of which the softening point is 80° C.˜300° C. is used, and preferably, a binder pitch of which the softening point is 90° C.˜180° C. is used.

\textcircled{2} Graphitization accelerant: The content of boron is 1% by weight˜10% by weight (based on final boron weight to carbon remaining after graphitization rather than boron source weight), and preferably, 2% by weight˜6% by weight.

A boron source may be boron (B), boric acid (H₃BO₃), diboron trioxide (B₂O₃), or boron carbide (B₄C), and any substance that increases the degree of graphitization is possible other than a boron source.

Forming (S160): It is a step of putting a compound of primary carbide/binder pitch/graphitization accelerant into a mold and heating·pressing the compound to improve the degree of graphitization and density.

Secondary carbonization heat treatment (S170): Secondary carbonization temperature is 500° C.˜1000° C., and preferably, 600° C.˜800° C., which is lower than the primary carbonization temperature. Since there is an objective of removing not only volatile components, but organic elements (S, N, O) in the primary carbonization heat treatment, it is required to perform heat treatment at a temperature of 1000° C. or more at which organic elements are actively discharged, but, in the secondary carbonization heat treatment, it is sufficient that volatile component removal of the binder pitch and carbonization are achieved, so secondary carbonization heat treatment is performed at a temperature of 1000° C. or less.

Graphitization heat treatment (S180): It is a step of preparing an artificial graphite negative electrode material by converting a carbon structure into a graphite structure, heat treatment at a temperature of 2500° C.˜3200° C. is required to maximally increase the degree of graphitization (crystallizability), and the treatment time is 10 minutes to 20 days.

Comminuting/Classifying (Secondary) (S190): It is comminuted and classified into 2 μm≤d₅₀≤50 μm to be suitable for the usage of an artificial graphite negative electrode material.

Artificial Graphite Negative Electrode Material for Rechargeable Lithium Battery

The present disclosure includes an artificial graphite negative electrode material for a rechargeable lithium battery prepared from the method of preparing artificial graphite negative electrode material from petcoke for rechargeable lithium battery.

According to the present disclosure, the gap d₀₀₂ of crystal planes of the artificial graphite negative electrode material for a rechargeable lithium battery may be 3.354 Å to 3.379 Å.

Further, the z-axial crystallite size L_{c} of the artificial graphite negative electrode material may be 19 nm to 100 nm.

Rechargeable Lithium Battery Made of Artificial Graphite Negative Electrode Material for Rechargeable Lithium Battery

The present disclosure provides a rechargeable lithium battery made of an artificial graphite negative electrode material for a rechargeable lithium battery.

### MODE FOR INVENTION

Hereafter, preferred embodiments are proposed to help understand the present disclosure, but the following embodiments just exemplify the present disclosure and the scope of the present disclosure is not limited to the following embodiments.

<Analysis Method>

Inductively coupled plasma optical emission spectroscopy (ICP-OES; Perkin Elmer, 170 Optima 5300DV and Thermo Fisher Scientific, iCAP 6500) was used for inorganic elemental analysis.

Elemental analysis (Thermo Scientific FLASH EA-2000 Organic Elemental Analyzer or Thermo Finnigan FLASH EA-1112 Elemental Analyzer) was used for organic elemental analysis.

Further, X-ray diffraction (XRD; Rigaku, SmartLab, Cu-Kα radiation or Philips X′Pert MPD, Cu-Kα radiation) was used for crystal structure analysis.

Further, Field emission scanning electron microscopy/energy dispersive X-ray spectroscopy (FE-SEM/EDS; Merlin Compact, Carl Zeiss AG/AZTEC, Oxford Instruments) was used for composition and surface analysis of a sample.

### Embodiment

### <Embodiment 1 to Embodiment 5> Preparing Artificial Graphite for Negative Electrode Material of Rechargeable Lithium Battery

Artificial graphite for a negative electrode material of a rechargeable lithium battery of Embodiment 1 to Embodiment 5 was prepared by a process of preparing artificial graphite including leaching acidifying, primary carbonization heat treatment, and graphitization heat treatment as shown in the following Table 1 from petcoke that is a raw material in accordance with the process diagram for artificial graphite for a negative electrode material of a rechargeable lithium battery of FIG. 2.

Drying (S110): Water contained in petcoke that is a raw material was removed through drying at a temperature of 120° C.

Comminuting/Classifying (Primary) (S120): The dried petcoke was comminuted/classified such that the average granular diameter became 45 μM to increase the leaching efficiency of inorganic impurities.

Leaching Acidifying (S130): Inorganic impurities were leached and removed by putting the classified powder petcoke into an acid solution shown in the following Table 1 and then stirring the acid solution for a predetermined time.

Remaining acid was removed by performing washing with high-purity water after the leaching acidifying.

The content of inorganic impurity elements was decreased to the level of 1/10 through the leaching acidifying.

Primary carbonization heat treatment (S140): Volatile components such as hydrocarbon and carbon dioxide were removed and organic impurities (S, N, O) in the petcoke were removed by performing carbonization heat treatment at a leached acidified temperature 1600° C. for 1 hour.

The entire content of organic impurities was reduced from 10.0% by weight before carbonization to 1.8% by weight through the primary carbonization heat treatment. Temperature rising speed was 5° C./min to 20° C./min

Kneading (S150): A primary carbide, a binder pitch of which the softening point is 120° C., and a boric acid (H₃BO₃) graphitization accelerant were used and mixed at the content shown in Table 4 for forming.

Forming (S160): A compound of primary carbide/binder pitch/graphitization accelerant was put into a mold, heated at 160° C., and pressed at 500 bar.

Secondary carbonization heat treatment (S170): Volatile components of the binder pitch were removed by performing secondary carbonization heat treatment on the molding at 900° C. for 1 hour, and then carbonization was performed.

Graphitization heat treatment (S180): Graphitization heat treatment was performed on a secondary carbide, which has undergone secondary carbonization heat treatment, at a temperature of 2800° C. for 10 minutes.

Comminuting/Classifying (Secondary) (S190): Artificial graphite for a negative electrode material of a rechargeable lithium battery was prepared by comminuting and classifying a graphitization heat-treated material such that the average granular diameter d50 became about 30 μm to be suitable for the use of an artificial graphite negative electrode material.

### <Comparative Example 1> Preparing Artificial Graphite for Negative Electrode Material of Rechargeable Lithium Battery

Artificial graphite for a negative electrode material of a rechargeable lithium battery was prepared by performing primary carbonization heat treatment and graphitization heat treatment in the same method as the Embodiment 1 except for not performing leaching acidifying after primary comminuting/classifying.

TABLE 1

| | Acid solution | | | Primary | Graphitiza- |
|---|---|---|---|---|---|
| | (% by weight) | | | carbonization | tion heat |
| | Hydro- | Sul- | Hydro- | heat treatment | treatment |
| | chloric | furic | fluoric | temperature | temperature |
| | acid | acid | acid | (° C.) | (° C.) |
| Embodiment 1 | 20 | 0 | 0 | 1600 | 2800 |
| Embodiment 2 | 0 | 20 | 0 | | |
| Embodiment 3 | 0 | 0 | 20 | | |
| Embodiment 4 | 0 | 0 | 10 | | |
| Embodiment 5 | 5 | 5 | 20 | | |
| Comparative | 0 | 0 | 0 | | |
| example 1 | | | | | |

### <Embodiment 6> Preparing Artificial Graphite for Negative Electrode Material of Rechargeable Lithium Battery

Artificial graphite for a negative electrode material of a rechargeable lithium battery was prepared by performing the process up to primary carbonization heat treatment in the same method as Embodiment 3 except that the primary carbonization heat treatment temperature was 1300° C.

### <Embodiment 6> Preparing Artificial Graphite for Negative Electrode Material of Rechargeable Lithium Battery

Artificial graphite for a negative electrode material of a rechargeable lithium battery was prepared by performing the process up to primary carbonization heat treatment in the same method as Embodiment 3 except that the primary carbonization heat treatment temperature was 1000° C.

### <Comparative Example 2> Preparing Artificial Graphite for Negative Electrode Material of Rechargeable Lithium Battery

Artificial graphite for a negative electrode material of a rechargeable lithium battery was prepared by performing the process up to primary carbonization heat treatment in the same method as Embodiment 3 except that the primary carbonization heat treatment temperature was 700° C.

### <Comparative Example 3> Petcoke Raw Material

Petcoke was prepared as a raw material

### Experiment Example

### <Experiment Example 1> Inorganic Impurity Content Analysis of Artificial Graphite According to Whether Leaching Acidifying is Performed

The content of inorganic impurities of coke (leachable) after leaching acidifying performed in Embodiment 1 to Embodiment 5 and the content of inorganic impurities of coke (leachable) that has not undergone leaching acidifying of Comparative example 1 were analyzed and shown in Table 2.

TABLE 2

| Unit (ppm) | Si | Al | Fe | V | Ni | Mo | Co | Pb | Total |
|---|---|---|---|---|---|---|---|---|---|
| Embodimenmt 1 | 4422 | 3011 | 1651 | 53 | 1077 | 420 | 6.1 | 6.0 | 10,645 |
| Embodimenmt 2 | 4520 | 3560 | 893 | 46 | 1040 | 387 | 4.2 | 3.9 | 10,454 |
| Embodimenmt 3 | 200 | 200 | 590 | 690 | 130 | 0 | 0 | 0 | 1,810 |
| Embodimenmt 4 | 419 | 735 | 585 | 1213 | 1213 | 585 | 5.2 | 4.3 | 3,496 |
| Embodimenmt 5 | 303 | 128 | 363 | 714 | 276 | 17 | 3 | 2 | 1,806 |
| Comparative | 4,480 | 3,780 | 1,580 | 1,050 | 395 | 53 | 5.5 | 6.6 | 11,350 |
| example 1 | | | | | | | | | |

The content of inorganic impurities of the coke (leachable) after leaching acidifying of hydrochloric acid of 20% by weight in Embodiment 1 was similar to the content of inorganic of the coke (leachable) after leaching acidifying of sulfuric acid of 20% by weight in Embodiment 2, and the content of inorganic impurities of the coke (leachable) after leaching acidifying of hydrofluoric acid of 20% by weight in Embodiment 3 was similar to the content of inorganic impurities of the coke (leachable) after leaching acidifying of mixed acid of hydrochloric acid of 5% by weight, sulfuric acid of 5% by weight, and hydrofluoric acid of 20% by weight in Embodiment 5.

The content of inorganic impurities of the coke after leaching acidifying of hydrofluoric acid of 10% by weight in Embodiment 4 was about double the content of inorganic impurities of the coke (leachable) after leaching acidifying in Embodiment 3 or Embodiment 5.

Further, the content of inorganic impurities of the coke (leachable) in Comparative example in which leaching acidifying was not performed was 11,350 ppm, that is, the content of impurities was high.

That is, it was found that the content of inorganic impurities greatly decreases from existing 11,350 ppm to 1,806 ppm by leaching acidifying.

### <Experiment Example 2> Analysis of Content of Organic Impurities after Primary Carbonization Heat Treatment

The content of organic impurities after primary carbonization heat treatment performed in Embodiment 3, Embodiment 6, and Embodiment 7, the content of organic impurities after primary carbonization heat treatment performed in Comparative example 2, and the content of organic impurities of the petcoke in Comparative example 3 were analyzed through elemental analysis and shown in Table 3.

TABLE 3

| | Primary | | | | |
|---|---|---|---|---|---|
| | carbonization | Content | Content | Content | |
| | heat treatment | of S | of N | of O | |
| | temperature | (% by | (% by | (% by | |
| | (° C.) | weight) | weight) | weight) | Total |
| Embodiment 3 | 1600 | 1.6 | 0.2 | 0.0 | 1.8 |
| Embodiment 6 | 1300 | 5.4 | 0.4 | 0.0 | 5.8 |
| Embodiment 7 | 1000 | 5.7 | 1.4 | 0.3 | 7.4 |
| Comparative | 700 | 6.2 | 1.6 | 1.4 | 9.2 |
| example 2 | | | | | |
| Comparative | — | 6.40 | 1.80 | 1.8 | 10.0 |
| example 3 | | | | | |
| (petcoke raw | | | | | |
| material) | | | | | |

The content of organic impurities was 1.8% by weight when the primary carbonization heat treatment was 1600° C. in Embodiment 3, which was very lower than 9.2% by weight that is the content of organic impurities when the primary carbonization heat treatment was 700° C. in Comparative example 2.

Further, the content of organic impurities in Embodiment 6 and Embodiment 7 was very lower than the content of organic impurities in Comparative example 2 and Comparative example 3.

### <Experiment Example 3> Analysis of Degree of Graphitization after Graphitization Heat Treatment

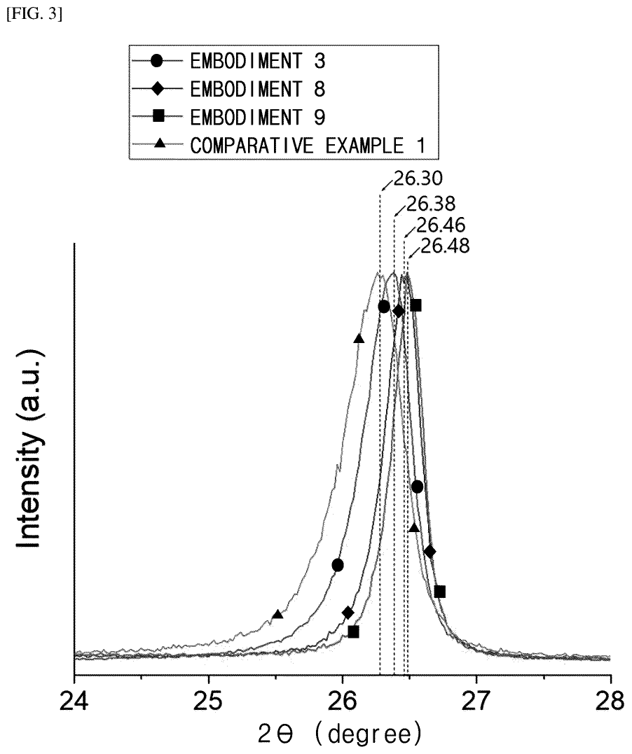

Graphitization heat treatment was performed on the primary carbonization heat treatment materials obtained in Embodiment 3, Embodiment 7, Embodiment 8, and Comparative example 1, and then the degree of graphitization according to the content of an additive was shown in Table 4 by analyzing an XRD pattern of FIG. 3. A samples that has undergone graphitization heat treatment at 2800° C. after primary carbonization heat treatment without leaching·acidifying was shown in Comparative example 1 for comparison.

FIG. 3 is a diagram showing an X-ray diffraction (XRD) pattern of artificial graphite for negative electrode materials of a rechargeable lithium battery prepared in Embodiment 3, Embodiment 8, and Embodiment 9, and Comparative example 1.

Referring to FIG. 3, the diffraction angles 2θ of a (002) plane of the artificial graphite for negative electrode materials of a rechargeable lithium battery prepared in Embodiment 3, Embodiment 8, and Embodiment 9, and Comparative example 1 were 26.38°, 26.46°, 26.48°, and 26.30°, respectively, and the diffraction angle 2θ of a (002) plane of the artificial graphite for negative electrode materials of a rechargeable lithium battery prepared in Comparative example 1 was small.

TABLE 4

| | | Primary | | | | | |
|---|---|---|---|---|---|---|---|
| | Whether | carbonization | | Content of | (002) | | |
| | leaching•acidi- | heat treatment | Graphitization | additive^{a} | interplane | Crystallite | Degree of |
| | fying was | temperature | temperature | (% by | distance | size L_{c} | graphitization |
| | performed | (° C.) | (° C.) | weight) | (Å) | (nm) | (%) |
| Embodiment 3 | Performed | 1600 | 2,800 | 0 | 3.376 | 19.6 | 74.7 |
| Embodiment 8 | Performed | | | 2 | 3.366 | 25.5 | 86.4 |
| Embodiment 9 | Performed | | | 4 | 3.363 | 29.5 | 89.3 |
| Comparative | not | | | 0 | 3.386 | 16.5 | 63.0 |
| example 1 | performed | | | | | | |

^{a}binder pitch and boric acid (H₃BO₃) graphitization accelerant

When leaching acidifying, primary carbonization heat treatment, and graphitization heat treatment processes were performed, the degree of graphitization of the artificial graphite negative electrode material of Embodiment 3, in which a binder pitch and an additive of boric acid (H₃BO₃) graphitization accelerant were not used in the kneading/forming process, was 74.7%, but the degrees of graphitization of the artificial graphite negative electrode materials Embodiment 8 and Embodiment 9 in which a binder pitch and an additive of boric acid (H₃BO₃) graphitization accelerant were used in the same process were 86.4% and 89.3%, respectively, which were increased by use of the binder pitch and additive of boric acid (H₃BO₃) graphitization accelerant and an increase of the content of the additive.

Further, when primary carbonization heat treatment and graphitization heat treatment processes were performed without leaching·acidifying, the degree of graphitization of the artificial graphite negative electrode material of Comparative example 3, in which a binder pitch and an additive of boric acid (H₃BO₃) graphitization accelerant were not used in the kneading/forming process, was 63.0%, which was very low.

That is, the higher the content of an additive, the higher the degree of graphitization, so it could be found that the degree of graphitization increased as small as up to 74.7% and as high as up to 87.9% and it could be found that the degree of graphitization was 63.0% that is very low when graphitization was performed without leaching.

Further, the (002) inter-plane distances d₀₀₂ of the artificial graphite negative electrode materials of Embodiment 3, Embodiment 8, and Embodiment 9 were 3.376 Å, 3.366 Å, and 3.363 Å, respectively, but the (002) inter-plane distance d₀₀₂ of the artificial graphite negative electrode material of Comparative example was 3.386 Å, that is, a large inter-plane distance was measured.

Further, the z-axial crystallite sizes L_{c} of the artificial graphite negative electrode materials of Embodiment 3, Embodiment 8, and Embodiment 9 were 19.6 nm, 25.5 nm, and 29.5 nm, respectively, but the z-axial crystallite size L_{c} of the artificial graphite negative electrode material of Comparative example 1 was 16.5 nm, that is, the z-axial crystallite size of the artificial graphite negative electrode material of Comparative example 1 was small.

### <Experiment Example 4> SEM Measurement of Artificial Graphite for Negative Electrode Material of Rechargeable Lithium Battery

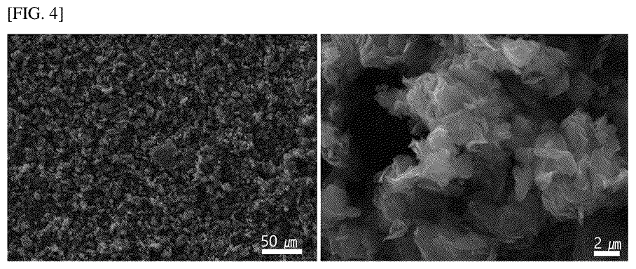

FIG. 4 is a scanning electron microscopic (SEM) image of the artificial graphite for a negative electrode material of a rechargeable lithium battery prepared in Embodiment 3.

Referring to FIG. 4, it could be found that the SEM image of the artificial graphite for a negative electrode material of a rechargeable lithium battery prepared in Embodiment 3 is formed in a plate-shaped flower shape.

### <Experiment Example 5> Cathode Performance of Rechargeable Lithium Battery

A charging/discharging test was performed using the artificial graphite samples of Embodiment 3, Embodiment 8, Embodiment 9, and Comparative example 1, and the result was shown in the following Table 5.

TABLE 5

| | | Primary | | | | |
|---|---|---|---|---|---|---|
| | Whether | carbonization | | Content of | | |
| | leaching•acidi- | heat treatment | Graphitization | additive^{a} | Degree of | Discharge |
| | fying is | temperature | temperature | (% by | graphitization | capacity |
| | performed | (° C.) | (° C.) | weight) | (%) | (mAh/g) |
| Embodiment 3 | Performed | 1600 | 2,800 | 0 | 74.7 | 299.0 |
| Embodiment 8 | Performed | | | 2 | 86.4 | 318.8 |
| Embodiment 9 | Performed | | | 4 | 87.9 | 322.4 |
| Comparative | Not | | | 0 | 63.0 | 277.1 |
| example 1 | performed | | | | | |

^{a}binder pitch and boric acid (H₃BO₃) graphitization accelerant

It could be found that as the degree of graphitization increased from Embodiment 3 to Embodiment 9, the charge capacity increased maximally up to 322.4 mAh/g, and it could be found that the charge capacity in Comparative example 1, in which graphitization was performed without leaching acidifying was 277.1 mAh/g, that is, was very small.

As in the embodiments described above, when an artificial graphite negative electrode material was prepared through the method according to the present disclosure, it was possible to manufacture a rechargeable battery having an improve capacity characteristic from inferior petcoke.

Embodiments about a method of preparing an artificial graphite negative electrode material from petcoke for a rechargeable lithium battery and an artificial graphite negative electrode material for rechargeable lithium battery prepared from the method according to the present disclosure were described above, but it is apparent that various modifications may be achieved without departing from the scope of the present disclosure.

Therefore, the scope of the present disclosure should not be limited to the embodiment(s) and should be determined by not only the following claims, but equivalents of the claims.

That is, it should be understood that the embodiments described above are not limitative, but only examples in all respects, the scope of the present disclosure is expressed by claims described below, not the detailed description, and it should be construed that all of changes and modifications achieved from the meanings and scope of claims and equivalent concept are included in the scope of the present disclosure.

### INDUSTRIAL APPLICABILITY

The present disclosure can be used for an artificial graphite negative electrode material for a rechargeable lithium battery, and a rechargeable lithium battery.

1. A method of preparing an artificial graphite negative electrode material from petcoke for a rechargeable lithium battery, the method comprising:
a step of drying petcoke that is porous cheap coke obtained by thermally decomposing petroleum-based heavy oil fractions of oil sand, vacuum residue, fluid catalytic cracking decant oil (FCC-DO), and light cycle oil (LCO);
a step of comminuting/classifying the petcoke;
a step of removing inorganic impurities by leaching [symbol] acidifying the comminuted/classified petcoke in an acid solution;
a step of obtaining a primary carbide by performing primary carbonization heat treatment on the petcoke with inorganic impurities removed;
a step of obtaining a secondary carbide by performing secondary carbonization heat treatment on the primary carbide; and
a step of obtaining artificial graphite by performing graphitization heat treatment on the secondary carbide at a temperature of 2500° C. to 3500° C.,
wherein the artificial graphite includes remaining inorganic impurities of 0.02% by weight to 6% by weight.

2. The method of claim 1, wherein the primary carbonization heat treatment is performed at a temperature of 1000° C. to 1900° C.

3. The method of claim 1, wherein the secondary carbonization heat treatment is performed at a temperature of 500° C. to 1000° C.

4. The method of claim 1, wherein the acid solution is used by diluting one or more acids selected from a group of hydrochloric acid, nitric acid, sulfuric acid, phosphoric acid, and hydrofluoric acid with water in the leaching·acidifying.

5. The method of claim 4, wherein the concentration of the acid solution is 2% by weight to 50% by weight.

6. The method of claim 1, wherein the weight ratio of the petcoke and the acid solution is 1:1˜1:30.

7. The method of claim 1, further comprising a step of removing remaining acid by performing washing with high-purity water after inorganic impurities are leached into the acid solution.

8. The method of claim 1, wherein the drying is performed at a temperature of 80° C. to 150° C.

9. The method of claim 1, wherein an average granular diameter d₅₀ of the petcoke after the comminuting/classifying is 1 μm≤d₅₀≤100 μm.

10. The method of claim 1, further comprising a step of kneading using the primary carbide, a binder pitch of which the softening point is 80° C. to 300° C., and a graphitization accelerant after the primary carbonization heat treatment.

11. The method of claim 10, wherein the graphitization accelerant is boron (B), boric acid (H₃BO₃), diboron trioxide (B₂O₃), or boron carbide (B₄C), and the weight of boron to the final carbon weight remaining after graphitization heat treatment is 1% by weight to 10% by weight.

12. The method of claim 10, further comprising a step of forming by heating/pressing a mixture of the primary carbide, the binder pitch, and the graphitization accelerant in a matrix (mold) after the kneading.

13. The method of claim 1, further comprising a step of comminuting/classifying after the graphitization heat treatment.

14. The method of claim 13, wherein an average granular diameter d 50 of graphite particles prepared after the graphitization heat treatment and the comminuting/classifying is 2 μm≤d₅₀≤50 μm.

15. The method of claim 13, further comprising a step of carbon coating after the graphitization heat treatment and before the comminuting/classifying.

16. An artificial graphite negative electrode material for a rechargeable lithium battery prepared by the method of claim 1.

17. The artificial graphite negative electrode material of claim 16, wherein a gap d₀₀₂ of crystal planes of the artificial graphite negative electrode material is 3.354 Å to 3.379 Å.

18. The artificial graphite negative electrode material of claim 16, wherein an z-axial crystallite size L_{c} of the artificial graphite negative electrode material is 19 nm to 100 nm.

19. A rechargeable lithium battery made of the artificial graphite negative electrode material for a for rechargeable lithium battery of claim 16.
